(19) United States
(12) Patent Application Publication
(10) Pub. No.: US 2004/0086083 A1
(43) Pub. Date: May 6, 2004

(54) Imaging medical examination apparatus

(76) Inventors: Peter Bier, Gremsdorf (DE); Stefan Doleschal, Grafenwoehr (DE); Hans Liegl, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/284,913

(22) Filed: Oct. 31, 2002

(51) Int. Cl. H05G 1/02

(52) U.S. Cl. 378/196

(57) ABSTRACT

An imaging medical examination apparatus, particularly an X-ray apparatus, has an electric motor for the drive of a movable component. The rotor of the motor is blocked when no drive current is supplied into the electric motor. The electric motor is a sliding rotor motor. The use of a self-inhibiting gearing can be foregone.

### BACKGROUND OF THE INVENTION

1. Field of the Invention

The present invention is directed to an imaging medical examination apparatus, particularly an X-ray apparatus, having a movable component and having an electric motor as a drive mechanism for the component.

2. Description of the Prior Art

Such examination apparatus are disclosed, for example, in German PS 195 38 054, German OS 41 35 177, Translation 693 22 303, Translation 694 20 231 and German PS 196 16 386.

It must be assured in medical-technical examination apparatus that unintentional movements of motor-driven parts or components of the examination apparatus do not occur, since such movements could jeopardize to the safety of the patient or of the operating personnel. For example, it must be assured that a tiltable patient support table on which a patient is lying at the moment does not pivot without an active motor drive into a position wherein the patient could fall off. A heavy X-ray tube carried by a stand must not move downwardly without an activation of the appertaining drive.

A retaining brake that is actively driven, usually by software, is, therefore present for arresting the part or the component. Despite the presence of such a retaining brake, an independent device or component movement, i.e. an unintentional movement without active drive, could be triggered by a fault or a short in the motor drive and/or brake drive. As a result of a short, for example, it could occur that the retaining brake is charged with voltage, i.e. is driven and thus is open, i.e. without braking effect, without the motor being driven at the same time. The consequence would be that the component to be moved or driven could drop downwardly.

For reasons of redundant safety, it is conventionally required to additionally provide a passive braking system. This has been accomplished, for example, by employing a self-inhibiting gearing that follows the motor and via which the rotary motion generated by the motor is transmitted to the component.

The known drive devices exhibiting this problem area have an electric motor, an active retaining brake and a self-inhibiting gearing as a passive system. Self-inhibiting gearings have the disadvantage of a very low efficiency. The result is that the electric motor must exhibit a very high power and the energy balance of the drive mechanism is poor overall.

### SUMMARY OF THE INVENTION

An object of the present invention is to provide a drive mechanism for an imaging medical examination apparatus that is able to operate with a lower power consumption.

In a medical examination apparatus of the type initially described, this object is inventively achieved by the rotor of the electric motor being blocked in the electric motor when no drive current is supplied into the electric motor. As used herein, “in the electric motor” means that the blocking that opposes turning of the rotor occurs in the function area of the electric motor, in the inside of the electric motor or within its outer envelope. The electric motor also particularly and at least partly exhibits the blocking when it is isolated from following components, for example from a gearing.

Such a motor exhibits an advantageous energy balance and also assures the required safety.

The electric motor is advantageously implemented such that the blocking can be cancelled by the influence of a magnetic force that is generated by the drive current.

For blocking the rotor, the electric motor preferably has a spring pressure brake according to the sliding rotor principle. In particular, the rotor can be moved in the axial direction by a magnetic force caused by the drive current.

The electric motor, for example, is a sliding rotor motor, particularly a sliding rotor motor of the type “KB” as distributed by the Mannesmann-DEMAG Company. For example, a sliding rotor motor is described in the catalogue entitled “Mannesmann Dematic, Getriebemotoren 1999/2000”, Catalogue No. 203 150 44, beginning with page 919 (date: 04/99), and in a data sheet of this company designated 203 15 05 a.pm6, page 379.

In the drive mechanism according to the invention, the self-inhibiting required for safety reasons is built into the electric motor, particularly a sliding rotor motor. The electric motor of the inventive examination apparatus always brakes given an outage of the current or voltage. As a result of its structure, the sliding rotor motor inherently produces the required safety.

In a preferred embodiment, the rotary motion generated by the electric motor can be transmitted to the component via a non-self-inhibiting gearing. An even higher efficiency is achieved by avoiding a self-inhibiting gearing. Accordingly, the electric motor can exhibit an especially low power compared to known drive mechanisms. The energy balance also is improved more.

In the examination apparatus of the invention with a drive mechanism as described above, the advantage also is achieved that no separate retaining brake need be present for the component to be driven. The braking function is implicitly co-effected given a sliding rotor. Accordingly, a brake drive and a software with respect thereto are also not required, so that the error tolerance is therefore also clearly enhanced.

The employment of a sliding rotor motor for a medical-technical examination apparatus may not seem meaningful since a sliding rotor motor is expensive and is constructed in a complicated way. Nevertheless, a detailed analysis of the overall drive concept heretofore. employed, namely using an electric motor, a retaining brake and a separate, self-inhibiting gearing, shows that the use of a sliding rotor motor is advantageous structurally as well as in terms of energy and costs.

Especially advantageously, the component driven by the drive mechanism is a support plate for a patient to be examined, since the secure positioning of the patient is of special significance.

For example, the drive mechanism is configured for longitudinal or height displacement and/or for a tilting motion of the support plate.

Likewise preferred, the component to be driven is a radiator stand (carrying, for example, an X-ray tube), an X-radiator and/or an aiming or: target device.

In the inventive examination or X-ray apparatus, a number of sliding rotor motors can be present for the drive of a number of components.

### DESCRIPTION OF THE DRAWINGS

FIG. 1 is a side view of an examination apparatus of the invention.

FIG. 2 is an example of an electric motor employed in the examination apparatus of FIG. 1.

### DESCRIPTION OF THE PREFERRED EMBODIMENTS

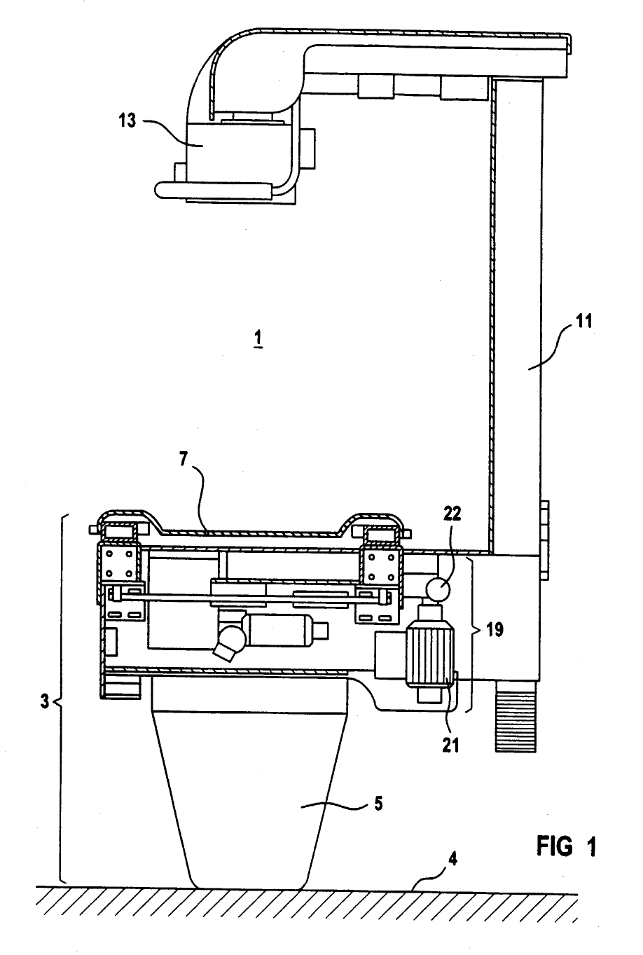

FIG. 1 shows an examination apparatus 1 that has a patient support mechanism 3. The patient support mechanism 3 has a base 5 supported on the floor 4 and a support plate 7 that can be moved axially, i.e. perpendicular to the plane of the drawing, and that also can be tilted and swiveled. A radiator stand 11 also is attached to be base 5, the stand carrying an X-ray tube or an X-radiator 13 via a boom.

For longitudinal movement of the support plate 7, a drive mechanism 19 is laterally provided at the patient support mechanism 3. This drive mechanism 19 has an electric motor 21 with a vertically-oriented shaft rotationally and a gearing 22.

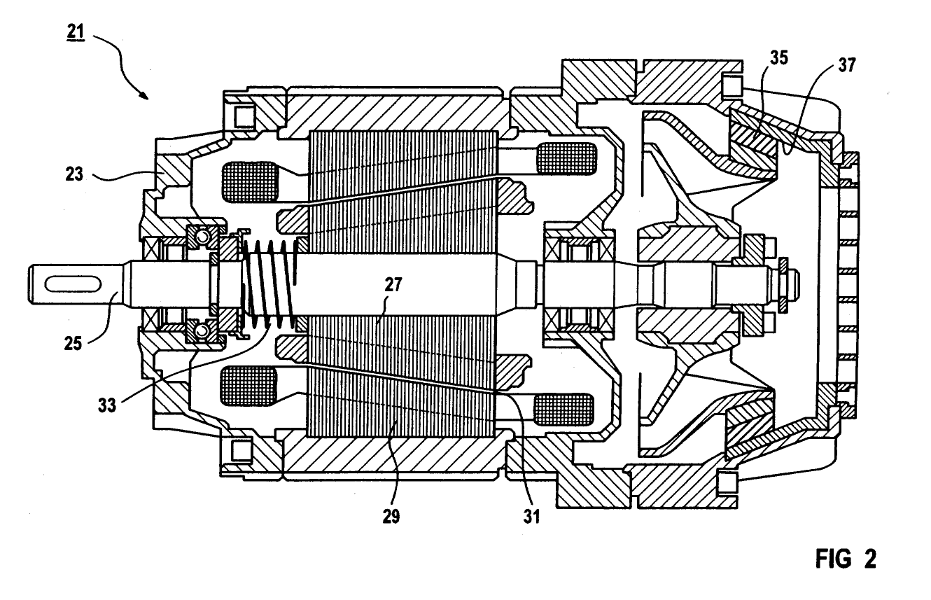

The electric motor 21 is a sliding rotor motor or sliding armature motor and is shown in detail in FIG. 2. The sliding rotor motor is a structural union of an electric motor with a spring pressure brake according to the sliding armature principle. It is implemented as a squirrel cage armature.

The electric motor 21 has a housing 23 in which a shaft 25 is seated. The shaft 25 carries a conical rotor 27. The inside of an appertaining stator is likewise conical, so that an air gap 31 is formed between the rotor 27 and the stator 29.

In its voltage-free condition, the electric motor 21 has a large air gap 31. In this condition, a brake spring 33 presses the rotor 27 out of the stator 29, i.e. toward the right in FIG. 2. A brake ring 35 is rigidly connected to the rotor 27 via the shaft 25. In this voltage-free condition, the brake spring 33 presses the brake ring 35 against a braking surface 37 at the housing 23. The electric motor 21 is then blocked, i.e. braked.

When a voltage is connected to the electric motor 21 so that a drive current flows for generating a rotary motion of the rotor flows, the conical envelope shape of the air gap 31 generates a magnetic axial force that attracts the axially displaceable rotor 27 up to the limitation in the stator 29 defined by the bearing and against the force of the brake spring 33. As a result thereof, the brake ring 35 releases from the braking surface 37, and the motor can start unimpeded. In this condition, the electric motor 21 has a small air gap 31.

As a consequence of the described principle, a separate drive is not required for the internal brake that is formed in the electric motor 21 itself.

The sliding rotor motor described in the example is an asynchronous three-phase motor. A frequency converter is employed for driving the motor.

Although modifications and changes may be suggested by those skilled in the art, it is the intention of the inventors to embody within the patent warranted hereon all changes and modifications as reasonably and properly come within the scope of their contribution to the art.

We claim as our invention:

1. A medical examination apparatus comprising:
an imaging arrangement for producing a medical image of a subject, said imaging arrangement including a movable component;
a drive mechanism connected to said movable component for moving said movable component, said drive mechanism including an electric motor operated with a drive current and having a rotatable rotor that is blocked in said electric motor in an absence of said drive current being supplied to said electric motor.

2. A medical examination apparatus as claimed in claim 1 wherein said electric motor comprises a spring pressure break operating according to the sliding armature principle for blocking said rotor.

3. A medical examination apparatus as claimed in claim 2 wherein said rotor is axially movable by a magnetic force produced by said drive current.

4. A medical examination apparatus as claimed in claim 1 wherein said electric motor is a sliding rotor motor.

5. A medical examination apparatus as claimed in claim 1 further comprising a self-inhibiting gearing mechanically connected between said electric motor and said component for transmitting rotary motion from said electric motor to said component.

6. A medical examination apparatus as claimed in claim 1 wherein said component is driven without a separate retaining brake.

7. A medical examination apparatus as claimed in claim 1 wherein said component is a support plate adapted to receive said subject thereon.

8. A medical examination apparatus as claimed in claim 7 wherein said drive mechanism displaces said support longitudinally and vertically.

9. A medical examination apparatus as claimed in claim 7 wherein said drive mechanism tilts said support plate.

10. A medical examination apparatus as claimed in claim 1 wherein said imaging arrangement is an X-ray imaging arrangement having an X-ray radiator supported on a radiator stand, and wherein said movable component is said radiator stand.

11. A medical examination apparatus as claimed in claim 1 wherein said imaging arrangement is an X-ray imaging arrangement having an X-ray radiator supported on a radiator stand, and wherein said movable component is said X-ray radiator.

12. A medical examination apparatus as claimed in claim 1 wherein said imaging arrangement is an X-ray imaging arrangement having a target device, and wherein said target device is said movable component.
